(19) United States
(12) Patent Application Publication
(10) Pub. No.: US 2026/0183179 A1
(43) Pub. Date: Jul. 2, 2026

(54) JAW OR FACIAL MASSAGING DEVICE AND METHOD OF MAKING AND USING SAME

(71) Applicant: Gabriel Newton, Burien, WA (US)

(72) Inventor: Gabriel Newton, Burien, WA (US)

(21) Appl. No.: 19/046,581

(22) Filed: Feb. 6, 2025

Related U.S. Application Data
(60) Provisional application No. 63/740,364, filed on Dec. 31, 2024.

(51) Int. Cl. A61H 15/00

(52) U.S. Cl. CPC A61H 15/0092; A61H 2015/0014

(57) ABSTRACT

A self-operated device particularly adapted for massaging a user's jaw, face or head affected by conditions such as muscle tension, headache or disfunction of the jaw, comprising two arms joined near the middle, each having a handle at the bottom and prongs at the top. Massaging members are mounted between the prongs at the top of each arm. A user may place their jaw, face or head between the two massaging members of the device to be acted upon by the massaging members, whereby the jaw, face or head is adjustably clamped between the pair of massaging members and massaged by translating and rotating movements of the handles along an axis parallel to the mounting axes of the massaging members.

### CROSS-REFERENCE TO RELATED APPLICATION

This application claims priority to and the benefit of U.S. Provisional Application No. 63/740,364, filed on Dec. 31, 2024, the disclosure of which is incorporated herein by reference in its entirety

### FIELD

The present disclosure relates to self-operated massage devices and their application and/or construction.

### BACKGROUND

There are currently a plethora of devices used to massage various parts of the body, including motor-driven percussive instruments, vibrating devices, rollers, heat applicators and pressure nodules, all designed to relieve tension and increase blood flow.

However, there are very few self-operated devices that are effective at alleviating tension in the face or jaw muscles. Many people experience tension in the jaw muscles, which can contribute to a whole host of problems, including Temporomadibular Joint disorder (TMJ), premature wear or cracking of teeth, frozen or misaligned jaw, difficulty opening or closing the mouth, facial pain, headaches, earaches, tennitus or just pain and discomfort in the jaw.

There exist facial rollers that do not apply enough force for most people to reduce tension in the jaw muscle and are primarily effective at stimulating the skin. There are also vibrating or heat emitting devices that are effective for some people, but the vibrating massagers currently available put a torsional force on the jaw which reduces the user's ability to apply the necessary pressure to achieve therapeutic results. For most users, the most effective means of reducing tension in the jaw muscles is via self-directed pressure delivered via a device with rollers, as this arrangement exerts an equal force to each side of the jaw, allowing greater pressure to be applied to the muscles of the jaw. There are currently massage devices that allow self-directed pressure with rollers, but they are all designed for other parts of the body and do not fit the anatomy of the face or jaw.

### SUMMARY

In light of the above, there is a need for a facial or jaw massaging device that allows the user to direct the exact placement and amount of pressure delivered by the rollers in order to effectively reduce tension and increase blood flow in the jaw and facial muscles. In order to deliver the necessary force to the rollers, a fulcrum can be employed much like a large pair of pliers.

The effective relief of muscle tension requires significant pressure, and needs to be applied with the ideal amount of force and in the exact spot(s) where it resides. There has yet to be a device that allows a user to apply the necessary force themselves, with both precise control of the location and amount of pressure.

The presently disclosed technology accomplishes the above and other objectives.

The following simplified summary of one implementation is provided in order to convey a basic understanding of the most common implementation. This summary does not provide an extensive representation of all contemplated implementations, and is not intended to identify key or critical elements of all implementations nor delineate the scope of all implementations. Its sole purpose is to present some concepts of the main implementation in a simplified form as a prelude to a more detailed description further on.

According to one implementation, a jaw massaging device includes two arms. Each arm has a roller attached at the top and a handle at the bottom. The two arms are connected via a fulcrum or pivot point roughly twice as close to the rollers as it is to the end of the handles, yielding mechanical advantage at the handles. The rollers may be attached to the arms via ball bearings to provide smooth rolling movement with reduced friction, or via a simple shaft.

According to another aspect, a tensioning member such as an elasticized band may be attached to the lower portion of the arms to reduce the amount of pressure on the handles required to achieve the desired amount of pressure exerted by the rollers.

According to another aspect, the arms may have multiple holes through which the pivot member may be mounted, as to provide different widths of the rollers for different sized faces.

According to another aspect, one arm may have a slotted guideway to receive the second arm so that the width of the rollers may be adjusted without fully disengaging the two arms from each other.

### BRIEF DESCRIPTION OF FIGURES

The nature and function of the present aspects may become more apparent from the detailed description below when considered in combination with the figures, wherein like numerals designate like elements throughout. For the purpose of illustrating the presently disclosed technology, there are shown in the drawings various illustrative embodiments. It should be understood, however, that the presently disclosed technology is not limited to the precise arrangements and instrumentalities shown.

FIG. 1 is a front elevation view of a facial or jaw massaging device according to one aspect of the presently disclosed technology.

FIG. 2 is a side elevation view of the device shown in FIG. 1.

FIG. 3 is a top plan view of the device shown in FIG. 1.

FIG. 4 is an oblique view of the device shown in FIG. 1.

FIG. 5 is another oblique view of the device shown in FIG. 1.

FIG. 6 is a detailed view of various rollers that can form part of the device shown in FIG. 1.

FIG. 7 is a detailed view of an upper end of one of the arms of the device shown in FIG. 1.

FIG. 8 is a front elevation view of the device shown in FIG. 1 including a tensioning member.

FIG. 9 is a detailed top plan view of the tensioning member shown in FIG. 8.

FIG. 10 is a front elevation view of a user employing the device shown in FIG. 1.

FIG. 11 is a front elevation view of a modified version of the device shown in FIG. 1.

### DETAILED DESCRIPTION

While systems, devices, and methods are described herein by way of examples and embodiments, those skilled in the art recognize that the presently disclosed technology is not limited to the embodiments or drawings described. Rather, the presently disclosed technology covers all modifications, equivalents, and alternatives falling within the spirit and scope of the appended claims. Specific details are provided in the following description to give a thorough understanding of the embodiments. However, someone of ordinary skill in the art will understand that the embodiments may be practiced without these specific details. Features of any one embodiment disclosed herein can be omitted or incorporated into another embodiment.

Any headings used herein are for organizational purposes only and are not meant to limit the scope of the description or the claims. Unless specifically set forth herein, the terms “a,” “an” and “the” are not limited to one element but instead should be read as meaning “at least one.” The terminology includes the words noted above, derivatives thereof, and words of similar import.

### OVERVIEW

Embodiments of the present disclosure are directed to a facial or jaw massaging device. The jaw massaging device may also be referred to as a jaw tension release device. The jaw massaging device is a hand operated apparatus (e.g., no motor or electronic power source) for the preventive or remedial treatment of muscular and joint disorders of the jaw and more specifically for the treatment of tension in the jaw and facial muscles that result in Temporomadibular Joint disorder (TMJ), premature wear or cracking of teeth, frozen or misaligned jaw, difficulty opening or closing the mouth, facial pain, headaches, earaches, tennitus or pain and discomfort in the jaw or face. In one embodiment, the device is in the form of a simple, yet efficient device that allows for stable and easily controllable application of rolling pressure to the muscles of the jaw or face. The device is controllable by the user or sufferer of the jaw or face pain and does not require application by a third-party or healthcare provider.

These and other valuable objects are achieved by a self-operated jaw massaging device that can include at least or only two arms joined near the middle, which can be controlled at the bottom by hand and positioned to any desired orientation, and provided with an opening at the top. The arms may be adjustable relative to each other, providing for use with varying sized faces or for ease of use. Massaging members installed in the top of the arms can be brought to work against the jaw or facial muscles while the bottom of the arms are pressed together with the hands of a user.

Flexible massaging members may be mounted or secured within the top section of the arms. The jaw or face may be placed between the two massaging members of the device, whereby the jaw or face is clamped (via pressure on the handles) between the pair of massaging members and massaged by translating and rotating movements of the massage members by pressing on and raising, lowering and rotating the handles.

Alternatively, the arms may be held together below the joint by a tensioning member, with or without the assistance of the hands of the user. The apparatus may compress the jaw or facial muscles from opposite sides to enhance blood and lymph circulation through muscle tissue and connective tissue. The relaxing effect on connective tissue and strengthening effect of active muscle release allows for a greater range of muscular motion and optimal function of the jaw. Moreover, the device increases the range of motion of the facial muscles subjected to massage, such that tight muscles do not incessantly pull on the jaw. Decreasing muscle tension is also relaxing and soothing for the user. The device has been designed for the user to apply several techniques including, but not limited to, Active Release/Trigger Point Therapy and Cross Fiber Friction and Myofasical Release Technique, all to specifically decrease muscle tension, increase blood flow, neuromuscular re-education and jaw function.

### Facial or Jaw Massaging Device

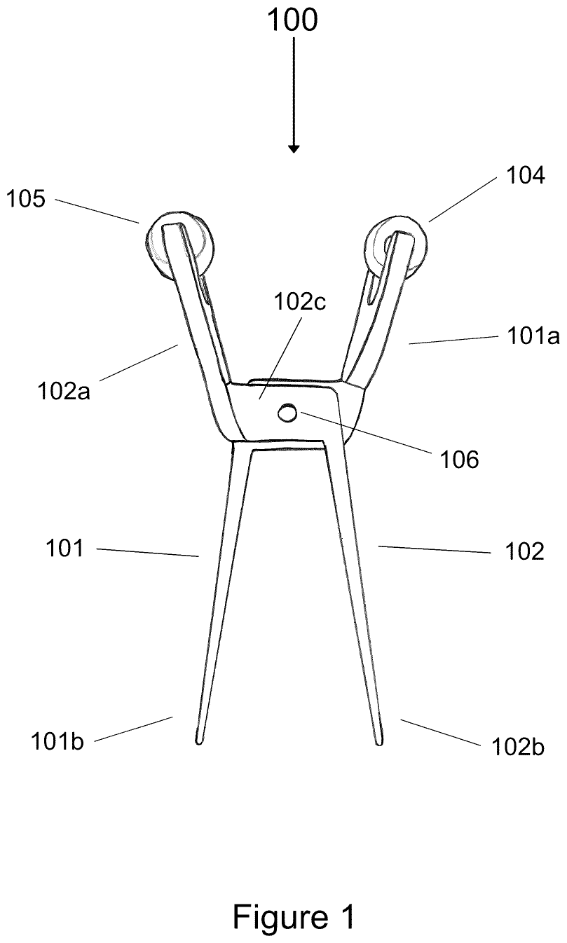

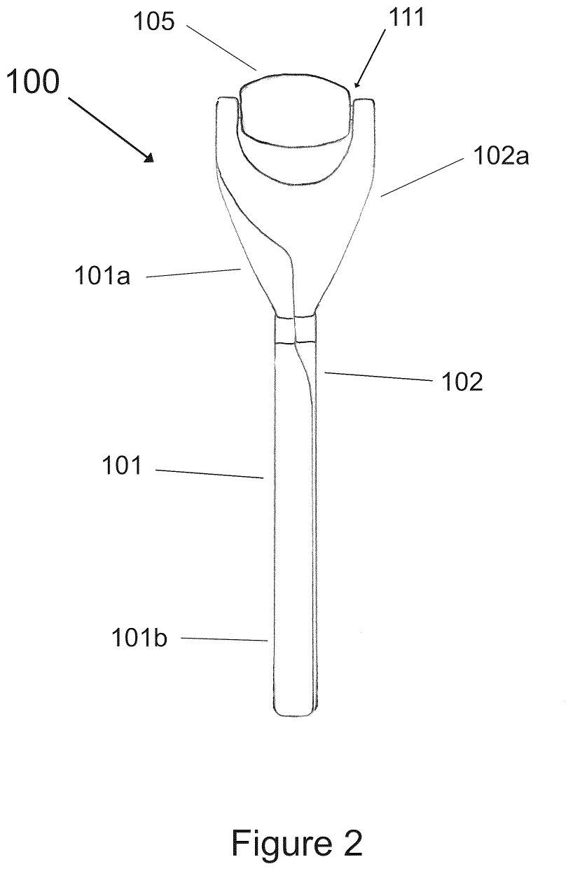

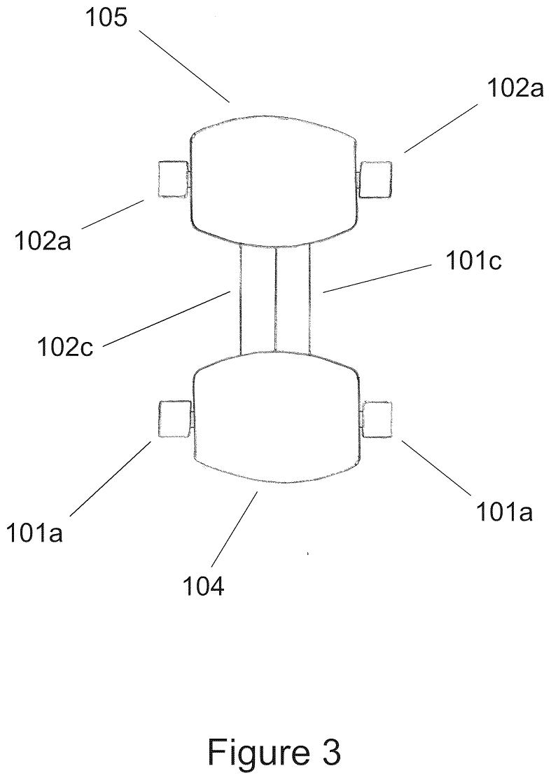

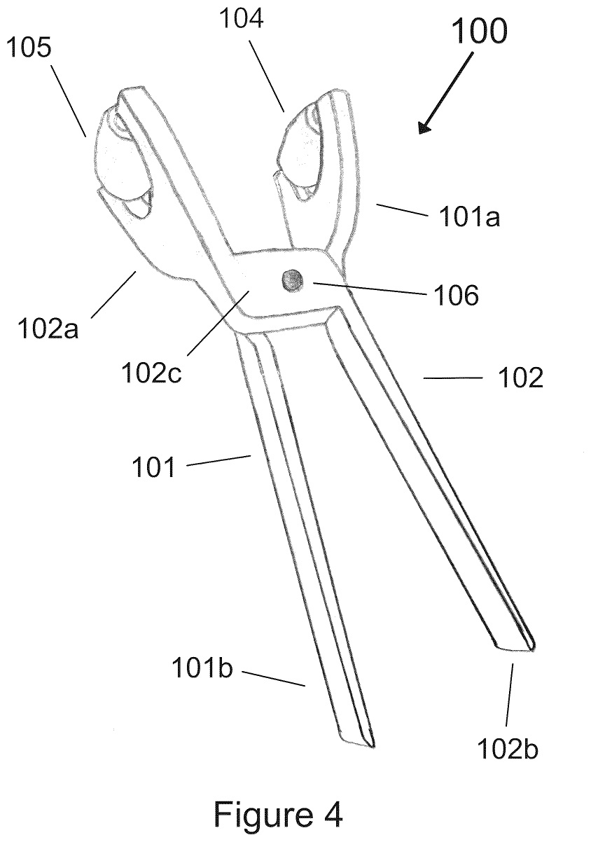

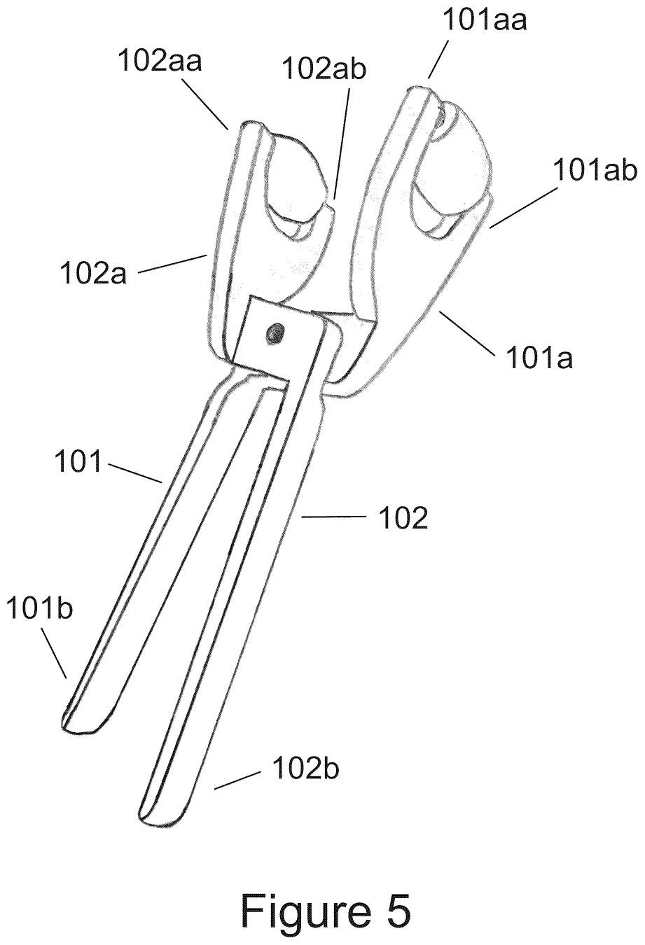

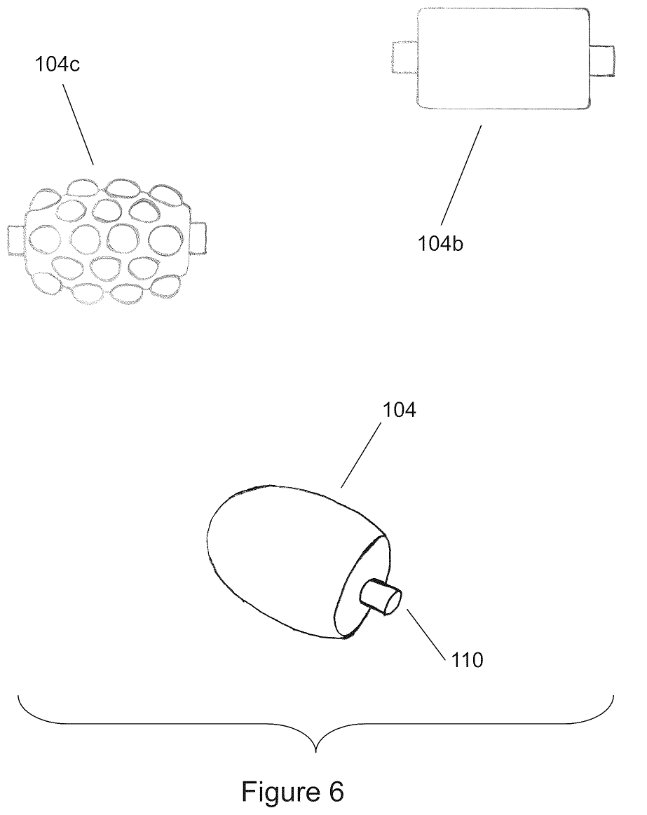

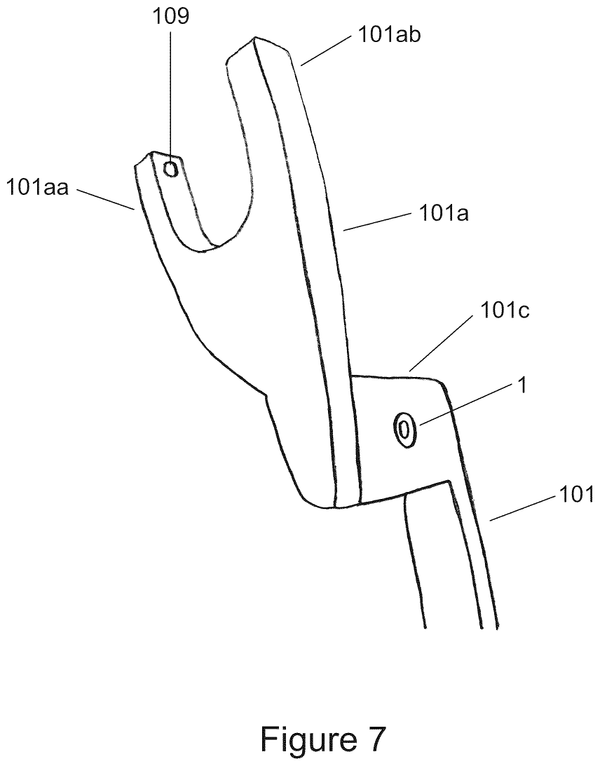

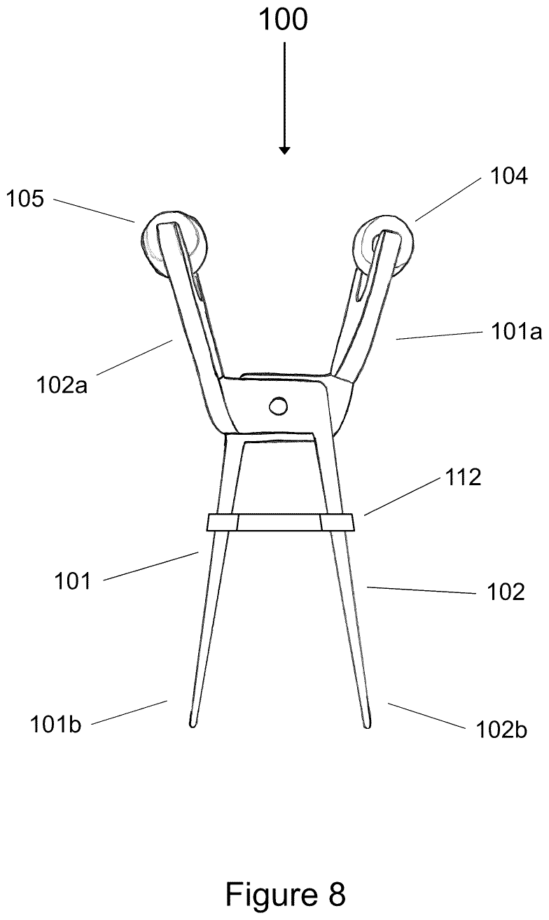

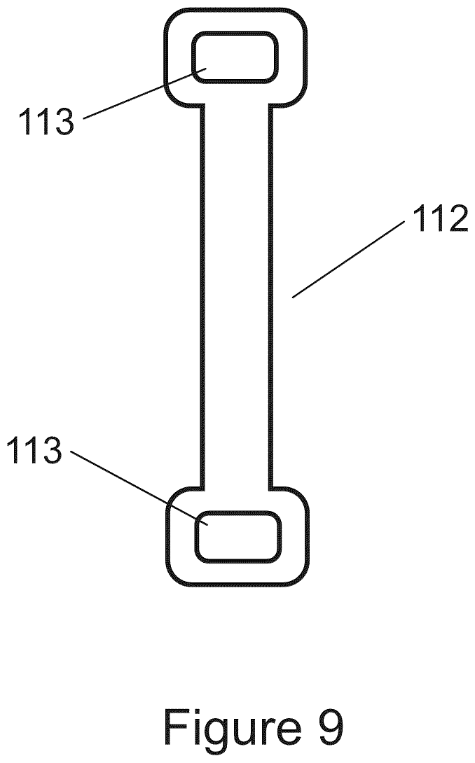

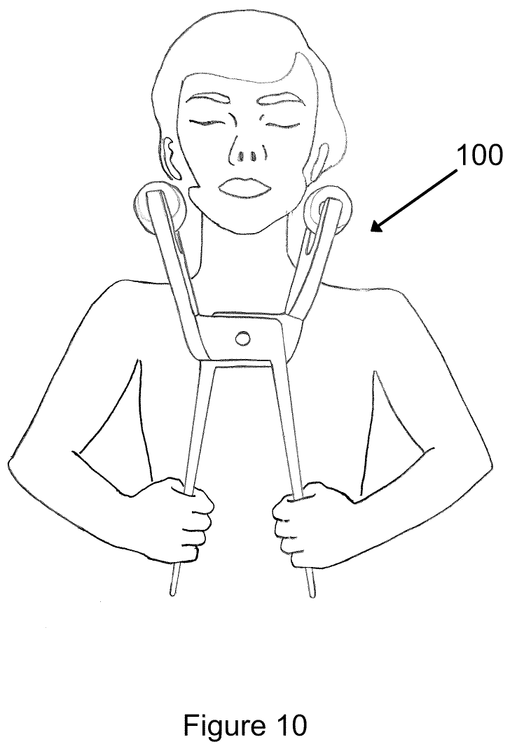

FIG. 1 is a front view of a jaw massaging device according to one aspect. FIG. 2 is a side view of the jaw massaging device in FIG. 1. FIG. 3 is a top view of the jaw massaging device in FIG. 1. FIG. 4 is an oblique view of the jaw massaging device in FIG. 1. FIG. 5 is another oblique view of the jaw massaging device in FIG. 1. FIG. 6 is a detailed view of a roller comprised by the jaw massaging device in FIG. 1. FIG. 7 is a detailed view of the upper end of one of the arms of the jaw massaging device in FIG. 1. FIG. 8 is a front view of a jaw massaging device including a tensioning member. FIG. 9 is a detailed view of a tensioning member comprised by the jaw massaging device in FIG. 8. FIG. 10 is a front view of a user employing the jaw massaging device in FIG. 1

The following discussion refers interchangeably to FIGS. 1-11.

As shown, the jaw massaging device 100 may include a first arm 101, having a first arm upper end 101a and a first arm lower end or handle 101b, and a second arm 102, also having an upper end 102a and a lower end or handle 102b. The first and second arms 101, 102 may be connected near the middle with a pivot member or cylindrical member 106 and maintained in an adjustable relationship to each other.

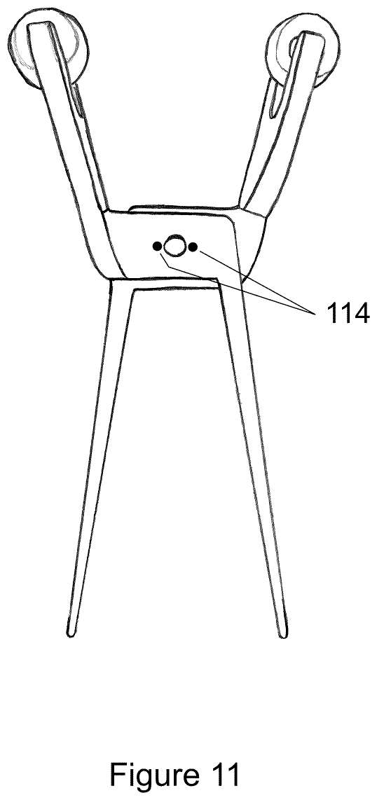

In another aspect (e.g., see FIG. 11), the cylindrical member 106 may be removed from one or both arms and placed in one of several separate and/or different apertures 114 in one of or each of the arms 101 and 102 so that the most desired width between the arms 101 and 102 may be achieved. In one aspect, the cylindrical or pivoting member may be an integral component of the first arm, onto which the second arm may be affixed. In a different aspect, the cylindrical or pivoting member may be separate from both arms, onto which both arms may be affixed. The example shown in FIG. 11 shows three spaced-apart apertures 114 in a linear or horizontal configuration. In this way, the first and second arms 101, 102 may be set by the user at various discrete distances from each other to create a desired gap or space (e.g., wider or narrower) between the arms 101, 102 by moving or rotating one or both of the arms 101 and 102 along an axis perpendicular to mounting axes of massaging members 104 and 105. The size of the gap may thereby be adjusted so that the gap can be adapted to receive and accommodate a jaw or face to which the jaw massaging device 100 is being used on. The jaw massaging device 10 may be movable in both an inward direction and an outward direction. The inward direction is defined where the first arm 101 and the second arm 102 are moved towards each other such that the massaging members 104 and 105 are applied inward towards the user's jaw. The outward direction is defined where the first arm 101 and the second arm 102 are moved away from each other, such that the massaging members 104 and 105 are applied outward, opening the gap to receive or remove the user's jaw therebetween.

First and second handles 101b and 102b (or lower ends of arms 101 and 102 respectively) are shown as having solid and flat configurations, this is by way of example only and the first and second handles 101b and 102b may utilize any configuration known in the art and may be hollow or tubular instead of solid. In the illustrated embodiment, the first handle 101b and the second handle 102b are of a greater length than the remaining portions of the first arm 101 and the second arm 102, respectively. As such, increased pressure can be applied by applying pressure to the distal ends of the first handle 101b and the second handle 102b while the remaining portions of the first arm 101 and the second arm 102 remain dimensioned to receive a jaw or face in the gap between the first massaging member 104 and the second massaging member 105.

The first and second arms 101 and 102 may each include an elongated section 101c and 102c in the middle allowing for the offset of the lower end of each arm 101b and 102b with the upper end of each arm 101a and 102a to provide a wider range of opening for the gap, more ease of use and more advantageous ergonomics, and also allowing for single handed operation. The first and second elongated members 101c and 102c are substantially parallel to each other when the jaw massaging device 100 is in the open position. and connected via a connecting or cylindrical member 106, which holds the arms together while allowing them to rotate (but in one embodiment not allowed to slide or translate) about the connecting or cylindrical member 106.

The first upper end 101a and first handle 101b are angled (e.g., perpendicular, as shown in FIG. 8) relative to the first elongated member 101c, wherein the first handle extends downward and outward from the elongated member and wherein the first upper end 101a extends upward and outward from the first elongated member 101c, in the opposite direction of the first handle 101b. The second upper end 102a and second handle 102b are angled relative to the second elongated member 102c, wherein the second handle 102b extends downward and outward from the second elongated member 102c and wherein the second upper end 102a extends upward and outward from the second elongated member 102c, in the opposite direction of the second handle 102b.

In one embodiment, the angle between the upper ends 101a and 102 and their respective elongated members 101c and 102c can effectively be anywhere between 60 and 140 degrees, and the angle between the elongated members 101c and 102 and their respective handles 101b and 102 can effectively be anywhere between 60 and 140 degrees.

The jaw massaging device 100 may be dimensioned for a user to place their jaw or face in the gap between the two massaging members 104 and 105. As such the jaw or face is adjustably clamped between the pair of massaging members 104 and 105 and massaged by pressing the handles 101b and 102b towards each other to achieve the desired pressure on the jaw or facial muscles and moving the first handle 101b and the second handle 102b upward and downward, causing the first massaging member 104 and the second massaging member 105 to rotate along the user's jaw or face, and by rotating the handles 101b and 102b forward and backward to adjust the direction of the rollers on the user's jaw or face.

The handles 101b and 102b may be coated with a material having a friction coefficient greater than 1 to prevent slippage. Such a coating makes them more easily to manipulate with one or both hands, thereby requiring less effort to achieve the desired pressure upon the massaging members 104 and 105. For example, the handles 101b and 102b may be coated with a rubber material or an adhesive.

According to one aspect, the upper end of the first and second arms 101a and 102a may include two prongs each (101aa, 101ab and 102aa, 102ab respectively, FIG. 5). Each massaging member 104 and 105 can be affixed between a respective pair of prongs. In this aspect, each prong may have an aperture 109 that passes all the way through the prong inline with the axis of the massaging members 104 and 105 respectively. In another aspect, the aperture may only be recessed into each prong a certain percentage of its thickness as in FIG. 7. The aperture 109 is dimensioned to receive an end of a substantially rigid shaft 110 of either the first massaging member 104 or the second massaging member 105 therein.

The first massaging member 104 may have an elongated configuration including a roller secured or mounted to a substantially rigid shaft 110 (FIG. 6) adapted or configured to be received within the apertures 109 securing the first massaging member 104 to the top of the first arm 101a. The first massaging member 104 may be rotatable by the roller rotating around the shaft 110 or the shaft 110 being rotatable when secured within the apertures 109 (FIG. 7). The roller may be formed of any type of material known in the art such as foam, rubber or plastic.

Likewise, the second massaging member 105 may have an elongated configuration including a roller secured or mounted to a substantially rigid shaft 111 (FIG. 2) adapted or configured to be received within the apertures 109 securing the second massaging member 105 to the top of the second arm 102a. The second massaging member 105 may be rotatable by the roller rotating around the shaft 111 or the shaft 111 being rotatable when secured within the apertures 102c and 102d. This roller may also be formed of any type of material known in the art such as foam, rubber or plastic.

Ball bearings may be employed between the rollers of massaging members 104 and 105 and their respective shafts or between the shafts of massaging members 104 and 105 and the apertures in the prongs of the upper ends of the two arms 102a and 102b to further reduce friction and increase the fine tuned control of exactly where the pressure is applied on the user's jaw or face. In an exemplary embodiment, the first massaging member 104 is removable from the first arm 101a and/or the second massaging member 105 is removable from the second arm 102a. As such, the first massaging member 104 and/or the second massaging member 105 may be replaceable. For example, a massaging member of a different configuration, such as described herein, may be desired.

In an exemplary embodiment shown in FIGS. 1-10, all portions of arms 101 and 102 have a substantially straight and substantially angular shape. Alternatively, the arms 101 and 102 may be of various curved or bent orientations, such as to increase ergonomics or ease of use for certain users.

When using the device 100, a user may place their jaw or face between the massage members 104 and 105 allowing the user to perform various different desired therapy techniques known in the art.

As shown in FIGS. 8 and 9, the device 100 may further include or be used with a tensioning device 112. The tensioning device 112 may be placed around the first and second arms 101 and 102 below the elongated members 101c and 102c to maintain or hold the handles or lower ends of the first and second arms 101b and 102b together in close proximity to each other. The tensioning device 112 may be used to supplement the user's hand in holding the first and second arms 101b and 102b in close proximity to each other, reducing the effort required to achieve the desired pressure of massage members 104 and 105 on the user's jaw or face, or allow the user to operate the jaw massaging device 100 with a single hand. In an exemplary embodiment, the tension applied by the tensioning member 112 may be adjustable by moving the tensioning member 112 upward and downward, wherein less tension is applied when the tensioning member 112 is closer to the elongated members 101c and 102c and more tension is applied when the tensioning member 112 is further from the elongated members 101c and 102c.

According to one example, the tensioning device 112 may be made of an elasticized material, such as a rubber band or a bungee cord, however a non-elasticized material may also be used. Use of an elasticized material allows the massage members 104 and 105 to apply an inward force directed towards each other while also providing for some amount of “give” with the massaging members 104 and 105 being able to move apart from each other when necessary, for example, when the jaw massaging device 100 is moved over a larger part of the jaw or face.

As shown in FIG. 9, the tensioning device 112 may alternately be constructed of a single solid band with an aperture 113 at each end so as to remain securely attached to the lower ends of the first and second arms 101b and 102b respectively. The tensioning device 112 may include multiple elasticized bands of different lengths and/or thicknesses, each providing a different amount of tension. Multiple tensioning devices may be used simultaneously to achieve different tensions, as required or desired. As a separable component, the tensioning device 112 may be selectively removed and replaced from the jaw massaging device 100 such as to replace the tensioning device 112 if it becomes too loose over time or to install a tensioning device 112 configured to generate a higher degree of tension.

FIG. 10 illustrates the use of the device 100 by a user. As shown in FIG. 10, the jaw of the user is placed between the first and second massage members 104 and 105 of the jaw massaging device 100. The user's hands can be used to manipulate the device 100 by moving the device 100 up and down and/or rotating and applying pressure to the lower ends of the first and second arms 101b and 102b.

### Massaging Members

To accommodate different needs of the user or to accommodate different users, the massaging members may have different configurations (FIG. 6). For example, in one configuration, the massaging members 104 and 105 may have a substantially ovoid, or egg shape. In the ovoid configuration, the roller can apply more pointed pressure to the muscles of the jaw or face. In another configuration, the massaging members 104 and 105 may have a cylindrical shape 104b. In the cylindrical configuration, the rollers can apply more even pressure to the muscles of the jaw or face. In yet another configuration, the massaging members 104 and 105 may have a substantially ovoid shape with a plurality of protrusions, or nubs, extending from its surface 104c. In the configuration with nubs or protrusions, the rollers can apply trigger point pressure to a larger area of the face or jaw as they are rolled over the affected area. The configurations of the massaging members shown are by way of example and other configurations known in the art may be utilized.

In an exemplary embodiment, the roller of the first massaging member 104 has an arcuate profile, such that greater pressure is applied from the middle of the roller. Furthermore, the roller of the first massaging member 105 has an arcuate profile, such that greater pressure is applied from the middle of the roller. In a further embodiment, the roller of the first massaging member 104 is identical in shape, size, material, and configuration to the roller of the second massaging member 105. As such, equal forces and pressures may be applied by the user on both sides of their jaw.

Due to the resilient nature of the massaging members 104 and 105, the contact pressure against the jaw or face may be automatically regulated. The material of the massaging members 104 and 105 is softer than the material comprising the first and second arms 101 and 102 so that the force on the muscles of the jaw or face can be refined and regulated using less effort. In one aspect massaging members 104 and 105 may be comprised of foam or rubber so that they allow the user to apply pressure to tense muscles of the jaw or face without slipping off abruptly. In another aspect the massaging members 104 and 105 may be comprised of plastic or metal and coated in silicone, foam or rubber. Alternatively, the massaging members 104 and 105 may be comprised of any material known in the art. The user retains full control of the applied massaging pressure at all times, which can be released instantly upon the user sensing any pain or discomfort. This instant feedback offers a substantial advantage over automatic massaging devices.

The following exemplary embodiments further describe optional aspects of the presently disclosed technology and are part of this Detailed Description. These exemplary embodiments are set forth in a format substantially akin to claims, although they are not technically claims of the present application. The following exemplary embodiments refer to each other in dependent relationships as “embodiments” instead of “claims”.

1A. A jaw massaging device, comprising: a first arm having a first arm upper end, an offset near the middle of the arm and a first arm lower end; a second arm having a second arm upper end, an offset near the middle of the arm and a second arm lower end; a cylindrical member that passes through the offset sections of the first arm and the second arm, connecting them such that they may rotate about the axis of the cylindrical member; a first massaging member secured within the top of the first arm; and a second massaging member secured within the top of the second arm.

1B. The device of embodiment 1A, further comprising a tensioning member comprising an elasticized band comprising an aperture at each end, adapted to be fitted to the first lower arm end and the second lower arm end for providing tension between the first and second arms.

1C. The device of claim 1, wherein the first and second arms and the first and second massaging members are shaped and dimensioned to adjustably compress a human jaw, face or head between the first massaging member and the second massaging member when the first arm lower end and the second arm lower end are held in close proximity to each other, whereby pressure that is applied to the jaw, face or head is variable and dynamically leveraged as the device is moved over the face, jaw or head.

2. A jaw massaging device, comprising: a first arm releasably engageable with, and disengageable from a second arm via a cylindrical member passing through apertures in the offset section of the first arm and the offset section of the second arm that can be engaged or disengaged; so that the first arm may be affixed to the second arm via a cylindrical member providing varying widths of the massaging members and the lower arm ends.

3. A massage apparatus comprising: a first arm comprising a first massaging member secured within the top of the first arm between two prongs; a second arm comprising a second massaging member secured within the top of the first arm between two prongs; the first arm releasably engageable with, and disengageable from the second arm via a cylindrical member passing through apertures in the offset section of the first arm and the offset section of the second arm that can be engaged or disengaged; wherein an arrangement of the first and second messaging members is suitable for massaging different portions of a single jaw, face or head disposed between the first and second messaging members.

While certain exemplary embodiments have been described and shown in the accompanying figures, it is to be understood that such embodiments are merely examples of and not restrictive on the broad invention, and that this invention is not limited to the specific constructions and arrangements illustrated and described, since various other modifications may occur to those ordinarily skilled in the art.

What I claim is:

1. A facial or jaw massaging device configured to be self-operated by a user without the assistance of a motor or electronic device, the device comprising:
a first arm having an upper end, a middle section, and a lower end, the middle section extending at a different angle than the upper and lower ends, the lower end of the first arm being configured to be grasped by a first hand of the user;
a second arm having an upper end, a middle section, and a lower end, the middle section of the second arm extending at a different angle than the upper and lower ends of the second arm, the lower end of the second arm being configured to be grasped by a second hand of the user;
a connecting member passing at least partially through the middle section of each of the first arm and the second arm, thereby connecting the first and second arms such that first and second arms are configured to rotate about a longitudinal axis of the connecting member;
a first massaging member secured within or attached to a top of the upper end of the first arm, the first massaging member being configured to contact the face or jaw of the user, the first massaging member being rotatable with respect to the upper end of the first arm; and
a second massaging member secured within or attached to a top of the upper end of the second arm, the second massaging member being configured to contact the face or jaw of the user, the second massaging member being rotatable with respect to the upper end of the second arm.

2. The device of claim 1, further comprising a tensioning member comprising an elasticized band comprising an aperture at each end thereof, the tensioning member being adapted to be fitted to the lower end of both the first and second arms for providing tension between the first and second arms.

3. The device of claim 1, wherein the first and second arms and the first and second massaging members are shaped and dimensioned to adjustably compress the face or jaw, of the user between the first massaging member and the second massaging member when the lower end of the first and second arms are held in proximity to each other, whereby pressure that is applied to the face or jaw of the user is variable and dynamically leveraged as the device is moved over the face or jaw.

4. The device of claim 1, wherein the connecting member extends through an aperture in the middle section of each arm.

5. The device of claim 4, wherein at least one of the arms can be separated from the connecting member.

6. The device of claim 1, wherein the connecting member extends through one of at least two lateral spaced-apart apertures in the middle section of each arm, and wherein at least one of the arms can be separated from the connecting member, thereby providing varying widths of the messaging members.

7. The device of claim 1, wherein the upper end of each arm includes two spaced-apart prongs, the first messaging member being located between the prongs of the first arm, the second messaging member being located between the prongs of the second arm.

8. The device of claim 1, wherein the lower end of the first arm extends at an angle away from the lower end of the second arm.

9. The device of claim 1, wherein the upper end of the first arm extends at an angle away from the upper end of the second arm.

10. The device of claim 1, wherein the upper end of the first arm extends along an axis, and wherein the middle section of the first arm extends at an angle between 60-140 degrees from the axis of the upper end of the first arm.

11. The device of claim 1, wherein the lower end of the first arm extends along an axis, and wherein the middle section of the first arm extends at an angle between 60-140 degrees from the axis of the lower end of the first arm.

12. The device of claim 1, wherein the first massaging device is configured to rotate about an axis that connects the first massaging device to the first arm.

13. The device of claim 1, wherein the first massaging device is configured to apply pressure on the face or jaw in a first direction, wherein the second massaging device is configured to apply pressure on the face or jaw in a second direction, the first direction being opposite the second direction.

14. A method of messaging your own face or jaw with a facial or jaw massaging device without the assistance of a motor or electronic device, the method comprising:
grasping a lower end of a first arm of the device with one of your hands;
grasping a lower end of a second arm of the device with the other of your hands;
pushing the lower end of the first arm toward the lower of the second arm, thereby moving an upper end of the first arm away from an upper end of the second arm;
placing your face or jaw between a first massaging device rotatably attached to the upper end of the first arm and a second massaging device rotatably attached to the upper end of the second arm;
pulling the lower end of the first arm away from the lower end of the second arm a sufficient distance such that the first massaging device contacts one side of your face or jaw and the second massaging device contacts an opposite side of your face or jaw; and
moving the device on your face or jaw to massage your face or jaw.

15. The method of claim 14, wherein each of the first and second massaging devices are configured to apply pressure in the opposite direction at which the lower end of the first arm is pulled away from the lower end of the second arm.

16. The method of claim 14, further comprising:
attaching a tensioning member to the lower end of the first arm and the lower end of the second arm.

17. The method of claim 14, further comprising:
applying and relaxing pressure on the lower end of the first and second arms to relax and apply pressure to your face or jaw.
